(19) United States
(12) Patent Application Publication
(10) Pub. No.: US 2019/0069491 A1
(43) Pub. Date: Mar. 7, 2019

(54) SYSTEMS FOR ENCASING ARTICLES IN A PROTECTIVE WRAP

(71) Applicant: Vermeer Manufacturing Company, Pella, IA (US)

(72) Inventors: Darin L. Dux, Pella, IA (US); Kent L. Thompson, Otley, IA (US); Curt T. Graham, Lynnville, IA (US)

(21) Appl. No.: 15/761,973

(22) PCT Filed: May 16, 2017
(86) PCT No.: PCT/US17/32801

§ 371 Date: Mar. 21, 2018

Related U.S. Application Data
(60) Provisional application No. 62/338,909, filed on May 19, 2016.

(51) Int. Cl. A01F 15/07; A01F 25/14; B65B 35/24

(52) U.S. Cl. CPC A01F 15/071; A01F 2025/142; B65B 35/243; A01F 25/14

(57) ABSTRACT

Systems for encasing articles such as forage or crop bales in a protective wrap are disclosed. In some embodiments, the system includes a packing conveyor that at least partially extends through a wrapping device for stretching a tube of wrapping material as articles pass through the wrapping device and into the protective wrap.

### CROSS-REFERENCE TO RELATED APPLICATION

This application claims the benefit of U.S. Provisional Patent Application No. 62/338,909, filed May 19, 2016, which is incorporated herein by reference in its entirety.

### FIELD OF THE DISCLOSURE

The field of the disclosure relates to systems for encasing articles in a protective wrap. In various embodiments the systems may include a packing conveyor that at least partially extends through a wrapping device for stretching a tube of wrapping material as articles pass through the wrapping device and into a protective wrap. An infeed conveyor may partially overlap with the packing conveyor to help transfer articles to the packing conveyor and into the wrapping device.

### BACKGROUND

Crop forages such as hay (e.g., alfalfa and/or grass hay) are periodically cut in the field, dried and compacted into bales for transport and storage of the forage material. In some cases and, in particular when silage material is baled, it may be desirable to wrap the bales in protective material such as plastic. Wrapping the silage promotes the ensiling process in which the material ferments, thereby improving the digestibility of the material for ruminants. Silage may be composed of various materials such as field crops or various grasses or legumes (i.e., alfalfa). In the case of forage bales, wrapping the bales allows the bales to be protected from rain and precipitation, which may degrade the nutrient value of the material.

It may be desirable to wrap a module of bales (e.g., two, three, four or even more bales wrapped together as a sealed unit). Such modules allow a small number of bales to be stored and later opened for livestock feeding without exposing a large number of bales to the ambient.

A need exists for an apparatus for wrapping bales in which the apparatus facilitates the advancement of a single bale or a module of bales through a wrapping device.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to a system for encasing articles in a protective wrap. The system has a lengthwise axis that extends from a front end to a discharge end of the system and over which the articles are conveyed. The system includes a wrapping device for stretching a tube of wrapping material as articles pass through the wrapping device and into the protective wrap. A packing conveyor at least partially extends through the wrapping device to convey articles into the protective wrap. The system includes an infeed conveyor for conveying articles to the packing conveyor. The infeed conveyor overlaps the packing conveyor with respect to the lengthwise axis.

Another aspect of the present disclosure is directed to a system for encasing articles in a protective wrap. The system includes a packing conveyor and a wrapping device for stretching a tube of wrapping material as articles pass through the wrapping device and into the protective wrap. The packing conveyor at least partially extends through the wrapping device to convey articles into the protective wrap. The wrapping device includes a base having a first end and a second end with the packing conveyor being disposed between the first and second ends. A first scissor mechanism is mounted to the base at the first end of the base. A second scissor mechanism is mounted to the base at a second end of the base. A third scissor mechanism is mounted to the first scissor mechanism and a fourth scissor mechanism is mounted to the second scissor mechanism. A fifth scissor mechanism connects the third and fourth scissor mechanism.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective top view of a system for encasing articles that is arranged for encasing large round bales in a protective wrap;

FIG. 2 is a perspective bottom view of the system for encasing articles;

FIG. 3 is a perspective view of a packing conveyor and wrapping device of the system, with the wrapping device in an extended position for wrapping bales;

FIG. 4 is a perspective view of the packing conveyor and wrapping device in an extended position, with a tube of wrap attached to the wrapping device;

FIG. 5 is a perspective view of the packing conveyor and wrapping device in a retracted position, with a tube of wrap attached to the wrapping device;

FIG. 6 is a perspective view of the system, with two bales loaded thereon for wrapping;

FIG. 7 is a perspective view of the system with the two bales being wrapped;

FIG. 8 is a top cross-section view of the wrapping device, two infeed conveyors, and the packing conveyor;

FIG. 9 is a rear view of two infeed conveyors, the packing conveyor and the wrapping device;

FIG. 10 is a side view of a discharge assembly of the system having discharge rollers for unloading bales; and

FIG. 11 is a perspective view of another embodiment of the packing conveyor in which the packing conveyor may be raised and lowered.

Corresponding reference characters indicate corresponding parts throughout the drawings.

### DETAILED DESCRIPTION

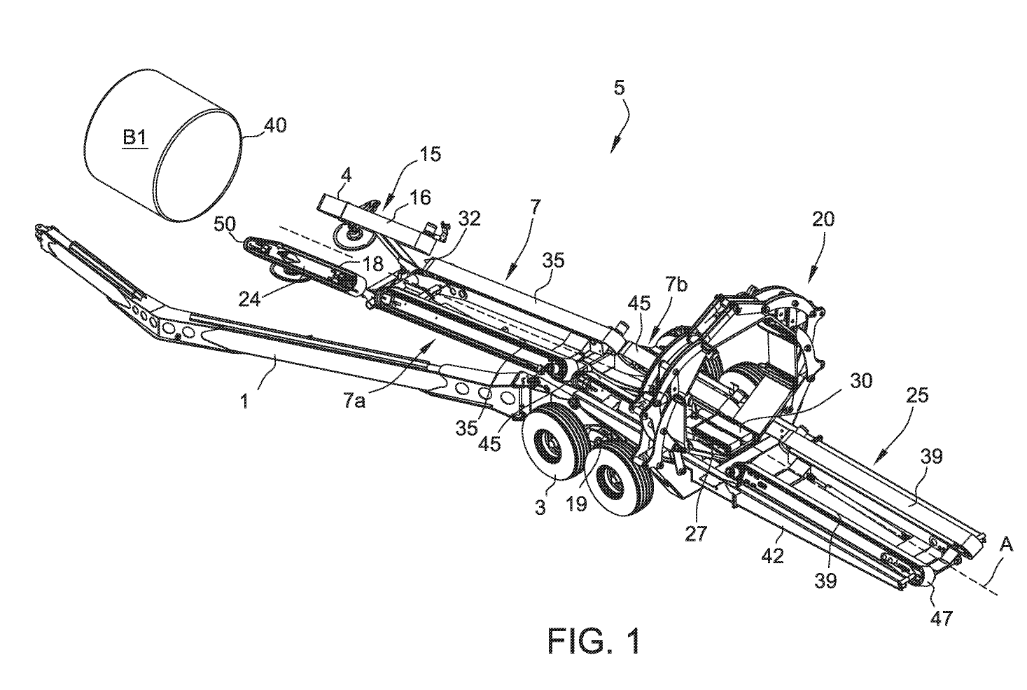

A system for encasing articles in a protective wrap is generally referred to as “5” in FIG. 1. While the system 5 is shown and may be described herein as a bale wrapping apparatus, the system should not be limited to a bale wrapping apparatus or other agriculture implement. The system 5 generally may be any device or apparatus in which a packing conveyor 30 extends through a wrapping device 20 (which may secure a tube of wrapping material) unless stated otherwise. For example, the system 5 may, in one variation, be non-mobile, and various articles may be loaded onto the system (as opposed to being picked up by the system itself) and processed to wrap the articles in a protective wrap. Suitable articles which may be wrapped include any articles wrapped for purposes of shipping and/or storage. In embodiments in which the system is a mobile bale wrapping apparatus, the articles may be small square bales, large square bales, or round bales of forage or crop material.

The system 5 (which may also be referred to herein in some variations as a “bale gathering apparatus”) includes a bed assembly 7 for supporting and conveying bales and a loading assembly 15 for lifting a bale from a bale-supporting surface (e.g., the ground) and conveying it to the bed assembly 7. The apparatus 5 also includes a discharge assembly 25 for conveying one or more bales (e.g., a “module” of bales) from a bale wrapping device 20 and for unloading the bales on a surface.

The apparatus 5 includes a tongue 1 for pulling the apparatus by use of, for example, a tractor or other pulling vehicle. In some embodiments (not shown) the apparatus 5 includes its own propulsion mechanism rather than being pulled by a pulling vehicle.

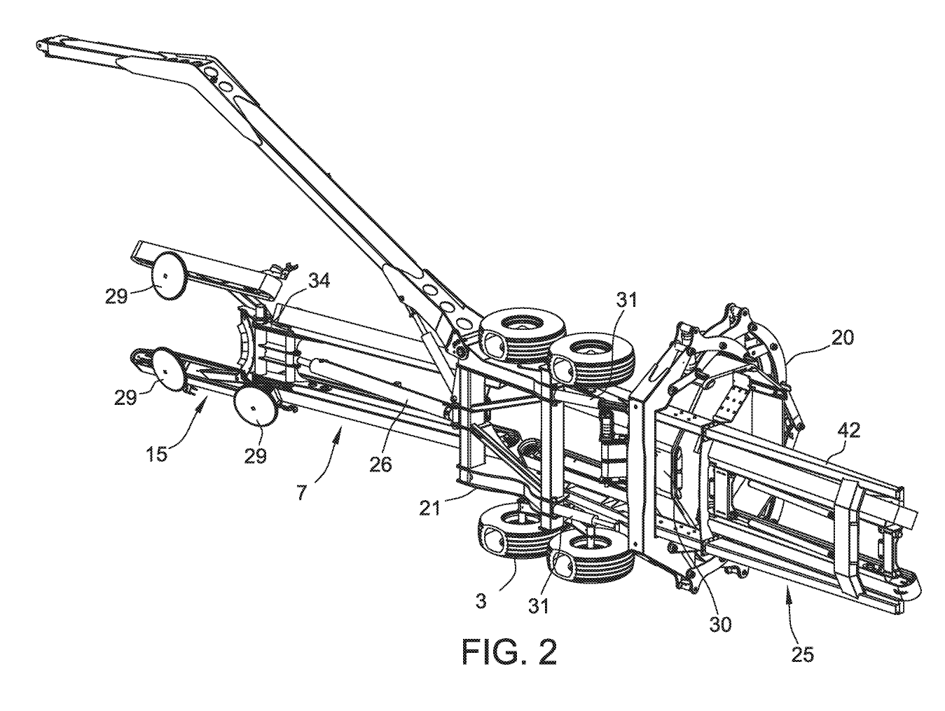

The apparatus 5 includes wheels 3. Tracks (not shown) may be used as an alternative to the wheels 3. The two wheels 3 on each side of the apparatus 5 are connected by a tandem axle 19 by use of hub and spindle assemblies (not shown). The tandem axles 19 are connected to a chassis 21 (FIG. 2). In other embodiments, the apparatus 5 includes a single wheel on each side or even more than two wheels on each side of the apparatus.

The loading assembly 15 and a forward portion 7a of the bed assembly 7 are supported by a bed frame 34 (FIG. 2). The bed frame 34 and, in turn, the loading assembly 15 and the forward portion 7a of the bed assembly 7 carried by the bed frame, are together pivotally attached to the chassis 21. An actuator 26 is connected to the chassis 21 and to the bed frame 34. The actuator 26 may be extended or retracted to allow the forward bed assembly 7a and loading assembly 15 to be tilted between various positions such as a loading position in which skids 29 contact the ground and a travel positon in which the loading assembly 15 is raised.

The rear bed assembly portion 7b, wrapping mechanism 20 and discharge assembly 25 are supported by a rear frame 42. The rear frame 42 and, in turn, the rear bed assembly 7b, wrapping mechanism 20 and discharge assembly 25 carried by the rear frame 42, are pivotally connected to the chassis 21. Discharge assembly actuators 31 connected to the chassis 21 and the rear frame 42 are used to pivotally raise and lower the rear bed assembly 7b and the discharge assembly 25 (e.g., for unloading of a module of bales onto the unloading surface). In this arrangement, the rear portion 7b of the bed assembly may pivot with respect to the forward portion 7a of the bed assembly (i.e., the bed conveyors 35 (described below) may pivot with respect to the infeed conveyors 45 (described below)).

The loading assembly 15 includes two arms 4, 24 that together are the leading portion of the apparatus 5 to contact a bale during loading. Each arm 4, 24 includes an endless conveyor belt 16, 18 looped around various drive, idler and/or support rollers for rotating the conveyor belt. In some cases the drive roller is positioned at the front, in some cases at the rear, and, in some embodiments, at both the front and rear. The movement of the belts 16, 18, around the front roller and backward along the upper portion of the belt path, is effective to lift a bale off the ground and simultaneously cause the bale to move toward the bed assembly 7. This lifting and transporting action occurs after the two conveyor belts contact a bale B1.

The arms 4, 24 are pivotally attached to the bed frame 34 (FIG. 2) that supports the conveyors of the bed assembly 7. In some embodiments, the arms 4, 24 pivot together and, in other embodiments, they may pivot separately. The arms 4, 24 may be attached by use of a pivot pin (not shown) or by any other suitable method which allows the arms 4, 24 to pivot relative to the bed assembly 7. Each side of the bed frame 34 may include a stop (not shown) which limits the downward pivot of the arms 4, 24 relative to the bed assembly.

It should be noted that the loading assembly 15 of the illustrated embodiment is exemplary and the apparatus 5 may include alternative or additional components that suitably lift bales from a surface and onto the apparatus 5.

The apparatus 5 has a loading end 50 (FIG. 1), discharge end 47 and a central lengthwise axis A that extends through the loading end and discharge end. In the illustrated embodiment, the first arm 4 and second arm 24 are substantially parallel to the lengthwise axis A.

The bed assembly 7 has a set of bed conveyors 35 (FIG. 1) add a set of infeed conveyors 45. The bed conveyors 35 are disposed between the loading arms 4, 24 and the infeed conveyors 45. The first and second bed conveyors 35 and first and second infeed conveyors 45 each form a cradle with bales being secured within the cradle as they are conveyed. The bed assembly 7 extends from a first end 32 to a second end 27. Each of the bed conveyors 35 and infeed conveyors 45 include an endless belt that may be routed around an idler roller and a powered roller (front or back) that may be rotated to cause the belt to move which results in moving bales away from the loading assembly 15 and toward the second end 27 of the bed assembly 7. Other conveyors arrangements, such a chain drive system, may be used.

In some embodiments, rather than having two conveyors that form a cradle, each section includes a single conveyor that forms a floor upon which the bales rest for moving bales toward the second end 27.

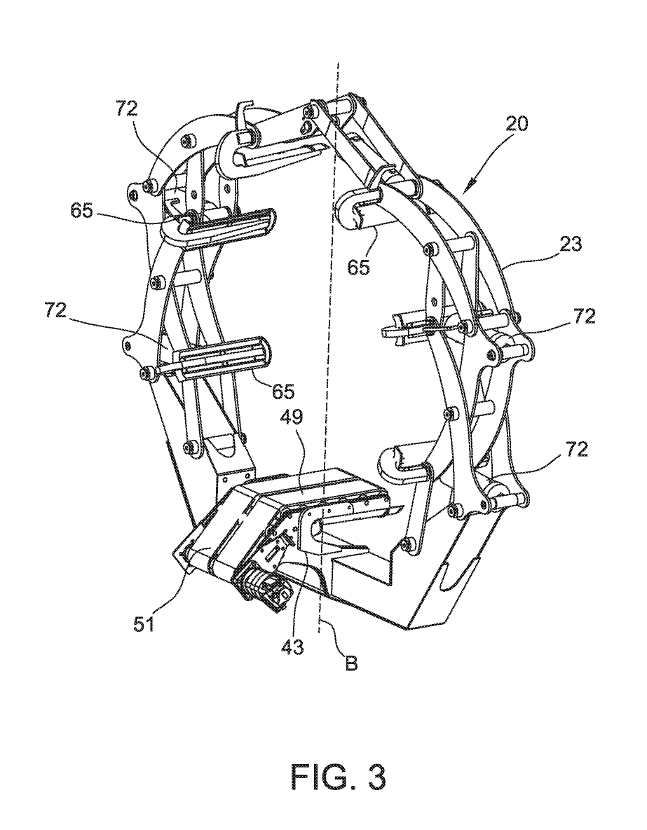

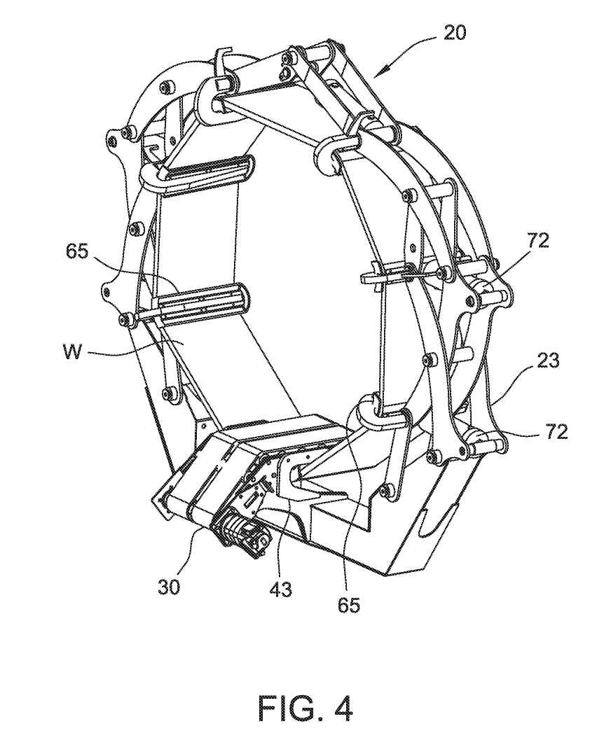

A bale wrapping device 20 is mounted to the rear frame 42 and between the rear portion 7b of the bed assembly 7 and the discharge assembly 25. Referring now to FIG. 3, the wrapping device 20 includes an articulating frame 23. The articulating frame 23 includes a number of attachment members 65. As shown in FIG. 4, a tube W of protective wrap material is fitted on the attachment members 65 such that the attachment members 65 are within the inner space formed by the material. The wrapping device 20 may have alternative configurations such as two separate arms that extend upward to which the attachment members 65 are attached, as shown and described in WO 2014/200337, which is incorporated herein by reference for all relevant and consistent purposes. Any suitable wrapping material may be used, such as commercially available LASTIC TUBE wrapping from AT Films (Edmonton, Canada).

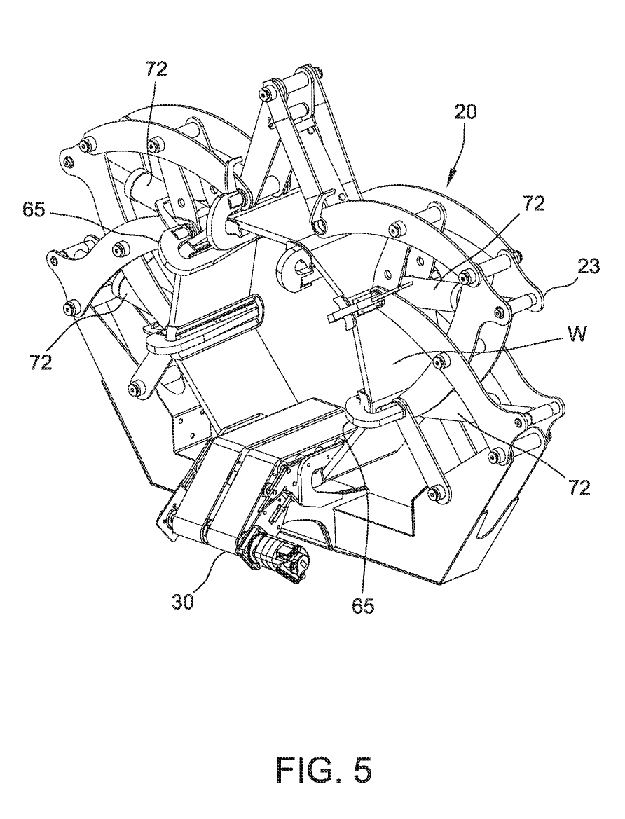

Actuators 72 (which may be hydraulic or pneumatic cylinders) may be extended to adjust the articulating frame 23 of the wrapping device 20 into a retracted position (FIG. 5) in which the tube of wrap material W may be slid onto attachment members 65. After placement of the wrapping material W, the actuators 72 may be retracted to adjust the articulating frame 23 into an extended position (FIG. 4) in which bales may pass through the device 20 and wrap W.

The articulating frame 23 of the bale wrapping device 20 includes a base having first and second ends and first and second scissor mechanisms mounted to the base on opposite ends of the packing conveyor 30 (described below). A third scissor mechanism is mounted to the first scissor mechanism and a fourth scissor mechanism is mounted to the second scissor mechanism. A fifth scissor mechanism connects the third and fourth scissor mechanism. Each scissor mechanism is operated by an actuator 72.

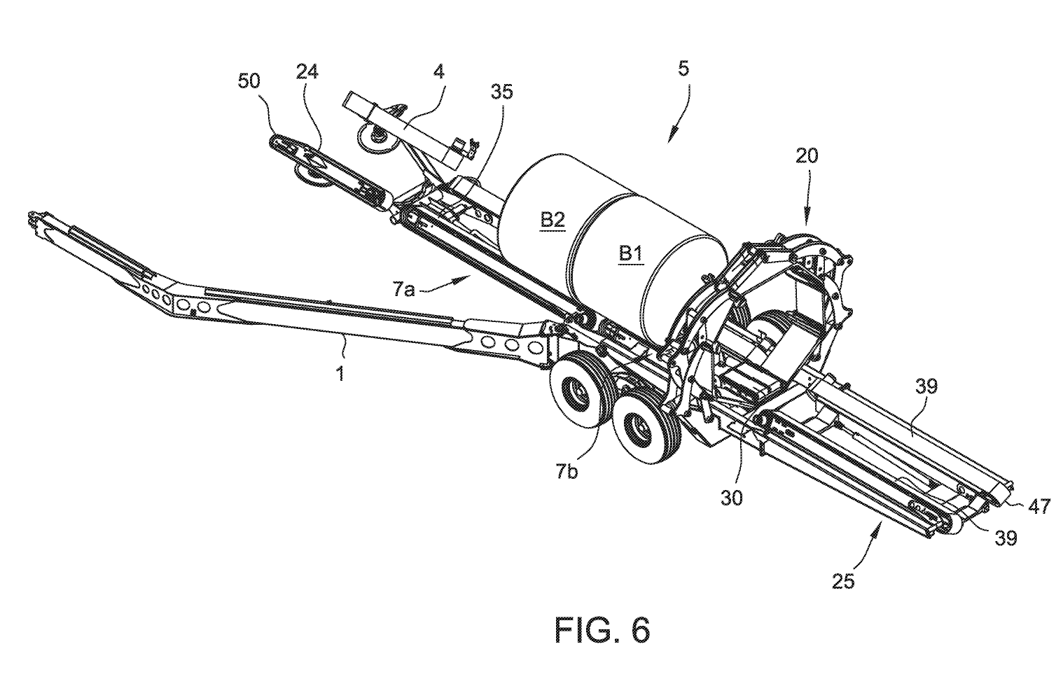

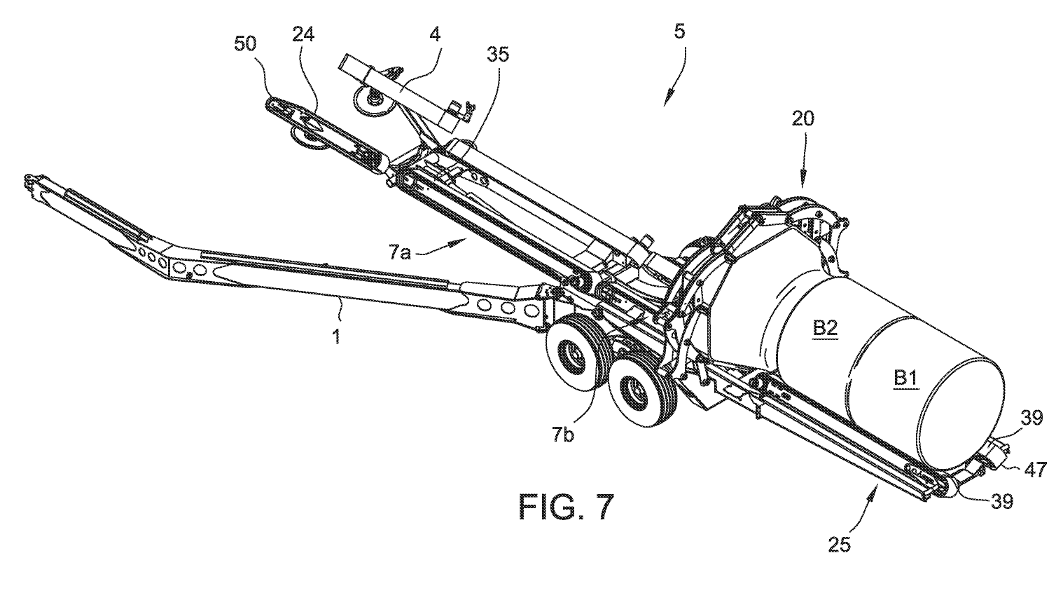

During wrapping, the wrapping device 20 is maintained with an inner radius greater than the radius of the bales to allow bales to pass through the wrapping device. As shown in FIG. 6, the bales are conveyed toward the discharge end 47 of the apparatus 5 causing the first bale B1 to contact a sealed end of the wrapping material (sealed end not shown). As bales continue to be conveyed through the wrapping device 20, further wrapping material is released. As the wrapping material is released, the wrapping material shrinks to the radius of the bales (FIG. 7).

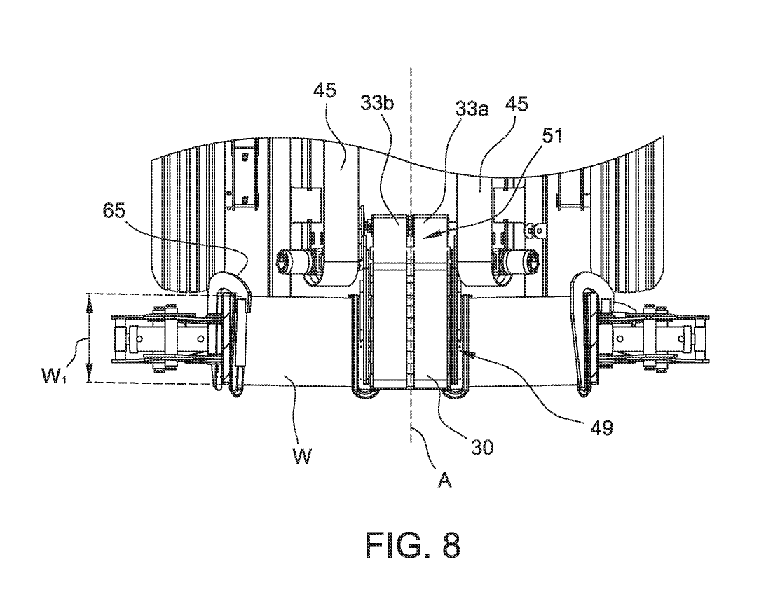

A packing conveyor 30 extends through the wrapping device 20 to convey articles into the tube of wrapping material W. As used herein and unless indicated otherwise, for the packing conveyor 30 to “extend through” the wrapping device indicates that the packing conveyor 30 at least partially overlaps the portion of the wrapping device 30 which contacts the wrapping material (i.e., the contact surface of the wrapping device being the surface of the attachment members) during bale wrapping with respect to the lengthwise axis A (FIG. 1). As shown in FIG. 8, the surface which contacts the plastic wrap W after mounting of the wrap and during wrapping of bales has a width W₁. In various embodiments, the packing conveyor 30 may extend to at least 20% of this width W₁ or at least 33%, at least 50%, at least 66%, at least 75% or across the entire width W₁ of the surface of the attachment members 65 which contact the plastic wrap W.

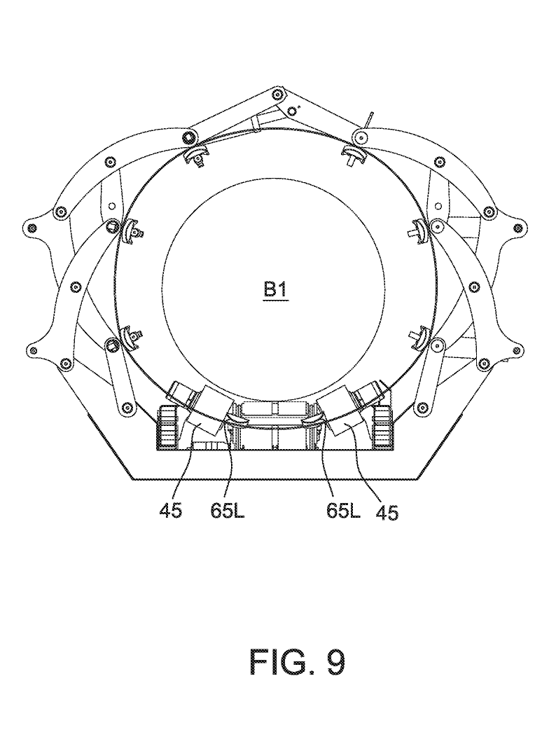

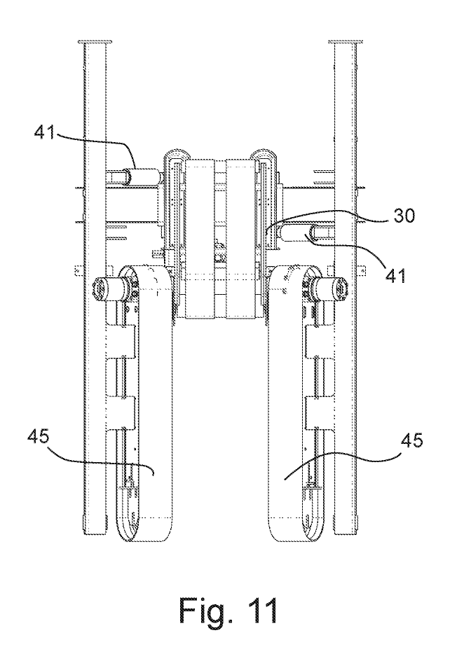

The packing conveyor 30 includes two conveyor belts 33a, 33b, each forming an endless loop. Each belt 33a, 33b has an upper surface upon which the bale is carried and a lower surface which returns the belt toward the loading end 50 (FIG. 1) of the apparatus 5. A portion of both the upper surface and lower surface of the belts 33a, 33b are within the opening formed by the wrap material (i.e., are above the lowest surface(s) of the wrapping device 20, which contacts and secures the wrapping material with respect to the vertical axis B (FIG. 3)). The packing conveyor 30 includes a rigid frame 43 (FIG. 3) that supports the belts 33a, 33b. As shown in FIG. 9, the rigid frame 43 rests on two lower attachment members 65L. The illustrated embodiment of the packing conveyor 30 includes two belts. In other embodiments, the packing conveyor 30 includes a single belt or may even include more than two belts. In some embodiments and as shown in Figure 11, the packing conveyor 30 may be raised and lowered (e.g., by operating actuators 41 shown as hydraulic cylinders).

In the illustrated embodiment, conveyor belts 33a, 33b are used to move bales through the wrapping device 20. In other embodiments, the packing conveyor 30 includes a number of powered rollers to move bales into and through the wrapping device 20.

Any conveyance mechanism (e.g., single belt, chain drive, powered or unpowered rollers, etc.) that facilitates movement of the wrapped bales toward the discharge end 47 of the apparatus 5 may be used unless stated otherwise.

As shown in FIG. 8, to facilitate conveyance of bales from the infeed conveyors 45 and through the wrapping device 20, the infeed conveyors 45 overlay (i.e., extend past) the packing conveyor 30 with respect to the lengthwise axis A. The packing conveyor 30 includes a horizontal portion 49 and an angular portion 51 that extends upward before contact with the bales.

The discharge assembly 25 conveys bales, which have been encased in the wrapping material W, from the packing conveyor 30 toward the discharge end 47 of the apparatus 5. In the illustrated embodiment, the discharge assembly 25 includes a set of discharge conveyors 39 that are supported by the rear frame 42. The discharge conveyors 39 form a cradle within which the bale is secured during transport. Similar to the bed conveyors 35 and infeed conveyors of the bed assembly 7, each discharge conveyor 39 of the discharge assembly 25 includes an endless belt routed around a front idler roller and a rear powered roller. The conveyors 39 may be rotated to cause the wrapped bales to move toward the discharge end 47 of the apparatus 5 for bale unloading.

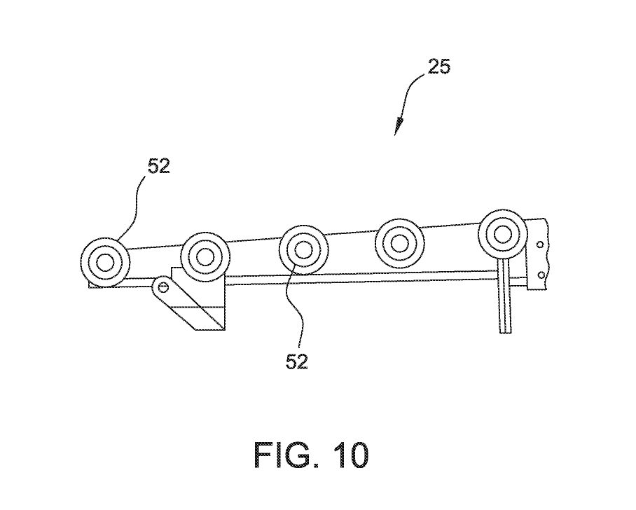

Any conveyance mechanism (e.g., single belt, chain drive, powered or unpowered rollers, etc.) that facilitates movement of the wrapped bales toward the discharge end 47 of the apparatus 5 may be used to discharge bales unless stated otherwise. In the illustrated embodiment of FIG. 10, the discharge assembly 25 includes powered or unpowered rollers 52. In some embodiments, the discharge assembly 25 is eliminated and the bales are discharged to the ground from packing conveyor 30.

The various conveyor belts of the system 5 may be driven by hydraulics, by a power-take-off system, or by an electrical drive. The drive system for driving the belts may be on-board (i.e., carried by the apparatus 5) or off-board (e.g., provided by a tow vehicle). Any suitable type of conveyer belts or conveyor systems may be included in the system 5 at any of the various locations where a conveyance mechanism is provided. For instance, a conveyor belt composed of nylon or fiberglass fibers covered by materials such as rubber, PVC, thermoplastic polymer or the equivalent may be used. Chain conveyor systems may also be used without departing from the scope of the present disclosure. In this regard, “conveyor belt” as used herein includes any arrangement in which a belt, chain, track or the like is moved around a series of pulleys, gears and/or drive wheels to cause movement of the belt, chain or track.

In some embodiments, each of the set of bed conveyors 35, set of infeed conveyors 45 and set of discharge conveyors 39 are independently controlled to allow bales to be indexed to form a module of two or more bales. In some embodiments, the infeed conveyors 35 and packing conveyor 30 are part of the same control circuit (e.g., operated in series in the same hydraulic circuit) and are controlled together (i.e., are operated to start and stop together and operate at the same speed).

The position of the loading apparatus 5 relative to the pull vehicle (i.e., whether the apparatus is pulled directly behind the pull vehicle or at an offset position, such as when bales are being gathered from the field) may be adjusted by manipulating the angle between the tongue 1 and the axis A of the apparatus by use of hydraulics or by any other method suitable to those of skill in the art. In other embodiments, the tongue 1 is eliminated, and the apparatus 5 may be self-propelled and/or driven autonomously through the field on which the bales rest.

In operation, the system 5 is pulled by the pull vehicle (not shown) toward a bale with the loading assembly in a downward loading position as shown in FIG. 1. The vehicle may provide the power for running the various conveyors and positioning systems (e.g., by use of hydraulics) or the apparatus 5 may include its own dedicated, (e.g., on-board) power system (e.g., hydraulic system). The apparatus described herein 5 uses a hydraulic system, but other power transfer technologies, such as an electrical system may be used.

The system 5 (e.g., loading and discharge conveyors, packing conveyor and wrapping device) may be sized to wrap a particular size of article. Generally, the system 5 handles bulk items such as articles having a smallest dimension (e.g., height, width, depth, length, and/or radius) of at least 0.5 meters or even at least 1 meter. The system 5 may be sized to wrap bales of forage material such as small square bales, large square bales, and/or cylindrical bales commonly referred to as “round” bales of forage or crop material.

The system illustrated in FIGS. 1-9 is suitable for picking up round bales. Round bales are used for harvesting any material capable of being formed into a cylindrical bale such as silage or traditional hay crops (e.g., alfalfa or grass), corn stover or other crop residues, cotton, or woody products like small diameter trees. The round bales may have a variety of sizes, typically ranging from 1 meter to 2.5 meters in length (about 40 to 100 inches). While the apparatus 5 is shown in FIGS. 1-9 as loading round bales, the apparatus may be adapted to pick up large square bales, small square bales, or other articles without limitation.

The speed of the packing conveyor 30 may be controlled to match the speed of the infeed conveyors 45 of the bed assembly 7. In some embodiments, the speed of the packing conveyor 30 is controlled to match the speed of the conveyors 39 of the discharge assembly 25. In other embodiments, the packing conveyor 30 is independently controlled from the discharge conveyors 39 and/or the bed conveyors 35 and/or the conveyors of the first and second arms 4, 24. Independent control of the various conveyors allows for indexing of bales to form various sizes of bale modules. In some embodiments, the system is controlled such that the bed conveyors 35, infeed conveyors 45, packing conveyor 30 and/or discharge conveyors 39 match the ground speed of the apparatus 5.

As shown in FIG. 1, the bale B1 and apparatus 5 should be oriented such that the ends 40 of the cylindrical bale are perpendicular to the apparatus 5 as the apparatus 5 approaches the bale B1. The chassis 21 and tongue 1 are caused to be at an angle relative to one another such that the loading assembly 15, bed assembly 7 and discharge assembly 25 travel outside of the path of the pull vehicle (not shown) to allow the pull vehicle to travel to the outside of a path established by the bales targeted for loading.

Bales are processed by transferring a bale from the surface on which it rests and onto the loading assembly 15 and onto the bed assembly 7. The bed assembly 7 moves the bale toward packing conveyor 30 which, in turn, propels the bale through the wrapping device 20. The bale contacts a sealed end of a tube of protective wrap W and begins to unfurl protective wrap from the tube causing the protective wrap to contract and surround the bale. The bale continues to moves through the wrapping device 20 and begins to contact the discharge assembly 25. After the bale is wrapped (and typically a module of bales is wrapped), the bale and/or the bale module, is unloaded from the discharge assembly 25.

Bales may be processed in the system 5 and wrapped in any suitable manner and order. For example, a single bale may be loaded onto the loading assembly 15 and transferred to the bed assembly 7. The apparatus 5 may then be moved to a second bale which is loaded onto the apparatus and caused to contact the first bale to form a module of bales. The module of bales may then be moved through the wrapping device. Modules may include more than two bales such as 3, 4 or 5 bales. Modules of more than 5 bales may be wrapped such as in embodiments in which an assembled line of bales is wrapped with the only practical limit of the number of bales being wrapped in a module being the length of the wrapping material. The loading assembly 15, bed assembly 7 and discharge assembly 25 may also wrap a prearranged row of bales.

After the last bale of the module has passed through the wrapping device 20, the wrapping material is sealed and cut to form a wrapped module. The loose end of the wrap may be sealed by any suitable method including use of clips, ties and heat melting of the plastic. After the bales are wrapped (or during wrapping for longer modules), the wrapped module is transferred to an unloading surface.

Compared to conventional systems for encasing articles in a protective wrap, the system described above has several advantages. The packing conveyor promotes movement of the bales (or module of bales) through the wrapping device. In embodiments in which modules of bales are wrapped, the set of infeed conveyors continues to push the stack of bales through the wrapping device. As the last bale of the module is pushed through the wrapping device, the last bale loses contact with the infeed conveyors. The packing conveyor is well suited to push the last bale of a module of bales by maintaining contact with the last bale as the bales transition to the discharge conveyor. In embodiments in which the infeed conveyor(s) overlap the packing conveyor with respect to the lengthwise axis, the bales more easily transition from the infeed conveyors to the packing conveyors and remain tightly packed in the module. This overlap also allows conveyors at different points on the lengthwise axis to drive or pull the bales forward through the bale wrapper (e.g., (1) infeed conveyors and packing conveyor contact bale or (2) packing conveyor and discharge conveyors contact bale). In some embodiments, the bale may contact three conveyor systems (infeed conveyors, packing conveyor and discharge conveyors) which push and pull the bale through the bale wrapper. By using a cradle of infeed conveyors that feed to the packing conveyor, the bales may move better across the bed assembly as compared to a single flat bottom packing conveyor.

By using a packing conveyor that supports the bale from below rather than a cylinder or other non-conveyance device that pushes the bales through the wrapping device, the apparatus may be more compact as no additional space is needed to accommodate such a cylinder or device.

In embodiments in which the bed assembly is split into two sections which are pivot to each other, the first section may better align with the loading assembly and the second section may better align with the packing conveyor.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

1. A system for encasing articles in a protective wrap, the system having a lengthwise axis that extends from a front end to a discharge end of the system and over which the articles are conveyed, the system comprising:
a wrapping device for stretching a tube of wrapping material as articles pass through the wrapping device and into the protective wrap;
a packing conveyor that at least partially extends through the wrapping device to convey articles into the protective wrap; and
an infeed conveyor for conveying articles to the packing conveyor, the infeed conveyor overlapping the packing conveyor with respect to the lengthwise axis.

2. The system as set forth in claim 1 further comprising a discharge assembly that conveys articles encased in protective wrap from the packing conveyor to a discharge end of the system.

3. The system as set forth in claim 2 wherein the discharge assembly comprises conveyors or rollers for conveying bales to the discharge end of the system.

4. The system as set forth in claim 1 wherein the system does not include a discharge assembly.

5. The system as set forth in claim 1 wherein the system has a lengthwise axis that passes through the infeed conveyor, packing conveyor and wrapping device, the infeed conveyor being a first infeed conveyor, the system comprising a second infeed conveyor opposite the first infeed conveyor and at the same position of the first infeed conveyor relative to the lengthwise axis to form a conveyor cradle, the first and second infeed conveyors both overlapping the packing conveyor with respect to the lengthwise axis.

6. The system as set forth in claim 1, the system further comprising:
a chassis that supports the wrapping device and packing conveyor; and
a plurality of wheels or tracks attached to the chassis for mobile operation of the system.

7. The system as set forth in claim 1 comprising a loading assembly for lifting articles from a surface on which the articles rest and on to the system.

8. The system as set forth in claim 7 wherein the loading assembly comprises:
a first arm comprising a first conveyor belt; and
a second arm comprising a second conveyor belt.

9. The system as set forth in claim 1 wherein the packing conveyor comprises a conveyor belt that rotates around an endless loop.

10. The system as set forth in claim 1 wherein the packing conveyor comprises a number of powered rollers.

11. The system as set forth in claim 1 wherein the system is sized to wrap articles having a width of at least 0.5 meters.

12. The system as set forth in claim 1 wherein the system is a bale wrapping apparatus and is sized to wrap at least one of small square bales of forage or crop material, large square bales of forage or crop material, and round bales of forage or crop material.

13. (canceled)

14. The system as set forth in claim 1 wherein the system has a lengthwise axis that passes through the packing conveyor and wrapping device, the wrapping device comprising one or more attachment members for securing the tube of protective wrap, the packing conveyor extending at least to the attachment members with respect to the lengthwise axis.

15. The system as set forth in claim 14 in combination with the tube of wrapping material, the tube of wrapping material being secured by the attachment members, the packing conveyor extending at least to the tube of wrapping material with respect to the lengthwise axis.

16. The system as set forth in claim 15 wherein the wrapping device comprises an actuator to extend the wrapping device by increasing its width to stretch the tube of protective wrap on the wrapping device.

17. The system as set forth in claim 1 wherein the wrapping device has a surface which contacts the protective wrap to secure the material during wrapping of the articles, the surface having a width W₁, the packing conveyor extending to at least 33% of the width W₁.

18. The system as set forth in claim 1 wherein the wrapping device has a surface which contacts the protective wrap to secure the material during wrapping of the articles, the surface having a width W₁, the packing conveyor extending to at least 50% of the width W₁.

19. The system as set forth in claim 1 comprising a bed conveyor that conveys articles to the infeed conveyor, the bed conveyor and infeed conveyor being capable of pivoting relative to each other.

20. (canceled)

21. A system for encasing articles in a protective wrap, the system comprising:
a packing conveyor; and
a wrapping device for stretching a tube of wrapping material as articles pass through the wrapping device and into the protective wrap, the packing conveyor at least partially extending through the wrapping device to convey articles into the protective wrap, the wrapping device comprising:
a base having a first end and a second end with the packing conveyor being disposed between the first and second ends;
a first scissor mechanism mounted to the base at the first end of the base;
a second scissor mechanism mounted to the base at a second end of the base;
a third scissor mechanism mounted to the first scissor mechanism;
a fourth scissor mechanism mounted to the second scissor mechanism;
a fifth scissor mechanism that connects the third and fourth scissor mechanism.

22. The system as set forth in claim 21 comprising an actuator associated with each scissor mechanism.
